(19) United States
(12) Patent Application Publication
(10) Pub. No.: US 2009/0179635 A1
(43) Pub. Date: Jul. 16, 2009

(54) System and Methods for Determining Motor Position

(75) Inventor: Clinton Cathey, Carlsbad, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/339,601

(22) Filed: Dec. 19, 2008

Related U.S. Application Data
(60) Provisional application No. 61/015,100, filed on Dec. 19, 2007.

(51) Int. Cl. G01B 7/30; H02P 8/36

(52) U.S. Cl. 324/207.25; 318/696

(57) ABSTRACT

According to the invention, a method for determining the radial position of a rotatable object is disclosed. The method may include providing targets at known relative radial positions coupled with the object, where a radial distance between any two adjacent targets is substantially not equal to the radial distance between any other two adjacent targets. The method may also include rotating the object about an axis, where the distance of the rotation is believed to be known. The method may further include determining, during rotation, that a first target is in proximity to a point fixed relative to the axis. The method may additionally include determining, during rotation of the object, that a second target is at least in proximity the point fixed relative to the axis. The method may moreover include comparing of the believed known rotation with the known relative radial positions of the plurality of targets.

### CROSS-REFERENCE TO RELATED APPLICATIONS

This application claims priority to Provisional U.S. Patent Application No. 61/015,100 filed Dec. 19, 2007, entitled “STEPPER MOTOR SLIPPAGE DETECTION FOR ANTENNA SYSTEMS,” the entire disclosure of which is hereby incorporated by reference, for all purposes, as if fully set forth herein.

### BACKGROUND OF THE INVENTION

This invention relates generally to motors and feedback systems therefore. More specifically the invention relates to systems and methods for determining the position of motors, possibly in the context of positioning motors for fixed or mobile antennas.

In some antenna systems, particularly mobile systems, size, weight, and cost considerations can rule out the implementation of conventional closed loop control systems with separate motors and continuous position sensors. Alternatively, stepper motors may be used, and the steps of the motor's movement may be counted to determine position. The home position of the motor may be determined by limit switches and/or proximity switches.

One problem with this approach is that there is no way to determine if the motor has slipped poles, thereby tracked position from the counting process in error. Embodiments of the instant invention provide solutions to this other problems.

### BRIEF DESCRIPTION OF THE INVENTION

In one embodiment, a method for determining the radial position of a rotatable object is provided. The method may include providing a plurality of targets at known relative radial positions coupled with the object, where a radial distance between any two adjacent targets is substantially not equal to the radial distance between any other two adjacent targets. The method may also include rotating the object about an axis, where the distance of the rotation is believed to be known. The method may further include determining, during rotation of the object, that a first target is at least in proximity to a point fixed relative to the axis. The method may additionally include determining, during rotation of the object, that a second target is at least in proximity the point fixed relative to the axis. The method may moreover include comparing of the believed known rotation with the known relative radial positions of the plurality of targets.

In another embodiment, a system for determining the radial position of a rotatable object is provided. The system may include a plurality of targets, a sensing device, and a processor. The plurality of targets may be in known relative radial positions coupled with the object, where a radial distance between any two adjacent targets is substantially not equal to the radial distance between any other two adjacent targets. The sensing device, possibly in a position fixed relative to an axis of the rotatable object, may be configured to determine, during rotation of the object, that any of the plurality of targets is at least in proximity to the sensing device. The processor may be configured to compare a believed known rotation of the rotatable object with the known relative radial positions of the plurality of targets.

In another embodiment, a system for determining the radial position of a rotatable object is provided. The system may include a first means, a plurality of targets, a second means, and a third means. The first means may be for rotating the rotatable object a distance, where the distance is believed to be known. The plurality of targets may be at known relative radial positions coupled with the object, where a radial distance between any two adjacent targets is substantially not equal to the radial distance between any other two adjacent targets. The second means may be for determining, during rotation of the object, that any of the plurality of targets is at least in proximity to the second means. The third means may be for comparing of the believed known rotation with the known relative radial positions of the plurality of targets.

### BRIEF DESCRIPTION OF THE DRAWINGS

The present invention is described in conjunction with the appended figures:

FIG. 1 is a geometric representation of one possible layout of targets of the invention;

FIG. 2 is a geometric representation of another possible layout of targets of the invention;

FIG. 3 is a block diagram of a method of the invention for determining an initial position of a rotatable object; and

FIG. 4 is a block diagram of another method of the invention for determining an initial position of a rotatable object;

FIG. 5 is a block diagram of a method for calibrating a system of the invention; and

FIG. 6 is a block diagram of another method for calibrating a system of the invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a method for determining the radial position of a rotatable object is provided. The method may include providing a plurality of targets at known relative radial positions coupled with the object, where a radial distance between any two adjacent targets may be substantially not equal to the radial distance between any other two adjacent targets. The method may also include rotating the object about an axis, where the distance of the rotation may be believed to be known. The method may further include determining, during rotation of the object, that a first target may be at least in proximity to a point fixed relative to the axis. The method may additionally include determining, during rotation of the object, that a second target may be at least in proximity the point fixed relative to the axis. The method may moreover include comparing of the believed known rotation with the known relative radial positions of the plurality of targets.

In some embodiments, the method may further comprise determining an initial radial position of the object based on a similarity of the believed known rotation and the known relative radial positions of the plurality of targets, as revealed by the comparison of the believed known rotation with the known relative radial positions of the plurality of targets. In these or other embodiments, the method may also include determining a current radial position of the object based on a similarity of the believed known rotation and the known relative radial positions of the plurality of targets, as revealed by the comparison of the believed known rotation with the known relative radial positions of the plurality of targets. In these or yet other embodiments, the method may include determining that an unintended slippage of the radial position of the object has occurred based on a discrepancy between the believed known rotation and the known relative radial positions of the plurality of targets, as revealed by the comparison of the believed known rotation with the known relative radial positions of the plurality of targets.

In some embodiments, providing a plurality of targets at known relative radial positions coupled with the object, where a radial distance between any two adjacent targets may be substantially not equal to the radial distance between any other two adjacent targets may include: (a) providing a first plurality of targets at evenly spaced distances from each other around the entire axis; and (b) providing a second plurality of targets, where each of the second plurality of targets may be located between two of the first plurality of targets, and each of the second plurality of targets may be located at a different relative position between the closest two targets of the first plurality of targets.

In other embodiments, providing a plurality of targets at known relative radial positions coupled with the object, where a radial distance between any two adjacent targets may be substantially not equal to the radial distance between any other two adjacent targets may include, in a sub-arc of the entire axis: (a) providing a first plurality of targets, where each of the first plurality of targets may be located within a first range of radial distances from adjacent targets in the first plurality of targets; (b) providing a second plurality of targets, where each of the second plurality of targets may be located within a second range of radial distances from adjacent targets in the second plurality of targets, where the second range may be of larger values than the first range; and (c) providing a third plurality of targets, where each of the third plurality of targets may be located within a third range of radial distances from adjacent targets in the third plurality of targets. The third range may be of larger absolute values than the first range, and the third plurality of targets may be at an opposite end of the first plurality of targets from the second plurality of targets.

In some embodiments, the method may also include storing a table of targets and their relative positions. In these methods, comparing of the believed known rotation with the known relative radial positions of the plurality of targets may include comparing the believed known rotation with at least a portion of the table.

In some embodiments, the rotatable object may include a motor shaft, possibly from a stepper motor. In embodiments where a stepper motor is at least associated with the rotatable object, the believed known distance may be the distance the stepper motor is commanded to move. In these or other embodiments, the rotatable object may include any one or more mechanical transmission element downstream from the motor shaft, including the final object to be driven by the transmission, or some portion thereof. In some embodiments, the final object to be driven may be an antenna.

In another embodiment of the invention, a system for determining the radial position of a rotatable object is provided. The system may include a plurality of targets, a sensing device, and a processor. The plurality of targets may be in known relative radial positions coupled with the object, where a radial distance between any two adjacent targets is substantially not equal to the radial distance between any other two adjacent targets. The sensing device, possibly in a position fixed relative to an axis of the rotatable object, may be configured to determine, during rotation of the object, that any of the plurality of targets is at least in proximity to the sensing device. The processor may be configured to compare a believed known rotation of the rotatable object with the known relative radial positions of the plurality of targets.

In some embodiments, the system may also include a data store including a table of targets and their relative positions. In these embodiments, the processor being configured to compare a believed known rotation of the rotatable object with the known relative radial positions of the plurality of targets may include the processor comparing the believed known rotation with at least a portion of the table.

In some embodiments, the processor may be further configured to determine an initial radial position of the object based on a similarity of the believed known rotation and the known relative radial positions of the plurality of targets, as revealed by the comparison of the believed known rotation with the known relative radial positions of the plurality of targets. In these or other embodiments, the processor may be configured to determine a current radial position of the object based on a similarity of the believed known rotation and the known relative radial positions of the plurality of targets, as revealed by the comparison of the believed known rotation with the known relative radial positions of the plurality of targets. In some embodiments, the processor may also be configured to determine that an unintended slippage of the radial position of the object has occurred based on a discrepancy between the believed known rotation and the known relative radial positions of the plurality of targets, as revealed by the comparison of the believed known rotation with the known relative radial positions of the plurality of targets.

In some embodiments, the rotatable object may include a motor shaft, possibly from a stepper motor. In embodiments where a stepper motor is at least associated with the rotatable object, the believed known distance may be the distance the stepper motor is commanded to move. In these or other embodiments, the rotatable object may include any one or more mechanical transmission element downstream from the motor shaft, including the final object to be driven by the transmission, or some portion thereof. In some embodiments, the final object to be driven may be an antenna.

In another embodiment of the invention, a system for determining the radial position of a rotatable object is provided. The system may include a first means, a plurality of targets, a second means, and a third means.

The first means may be for rotating the rotatable object a distance, where the distance is believed to be known. In some embodiments, the first means may be any system, device or apparatus discussed herein capable of rotating the rotatable object a distance, where the distance is believed to be known. Merely by way of example, in some embodiments, the first means may be at least a portion of a motor, for instance, a shaft rotated by the motor, possibly the shaft of a stepper motor. The first means may also be any now-existing or future-existing equivalent to the above referred-to systems, devices, or apparatuses.

The plurality of targets may be at known relative radial positions coupled with the object, where a radial distance between any two adjacent targets is substantially not equal to the radial distance between any other two adjacent targets. As described above, the targets may be provided in any number of possible manners which subscribe to the above description.

The second means may be for determining, during rotation of the object, that any of the plurality of targets is at least in proximity to the second means. In some embodiments, the second means may be any system, device or apparatus discussed herein capable of determining, during rotation of the object, that any of the plurality of targets is at least in proximity to the second means. Merely by way of example, in some embodiments, the first means may be a sensing device, for instance, a proximity sensor, optical sensor, laser device, etc. The second means may also be any now-existing or future-existing equivalent to the above referred-to systems, devices, or apparatuses.

The third means may be for comparing of the believed known rotation with the known relative radial positions of the plurality of targets. In some embodiments, the third means may be any system, device or apparatus discussed herein capable of comparing of the believed known rotation with the known relative radial positions of the plurality of targets. Merely by way of example, in some embodiments, the third means may be a processor, for instance, a programmable logic controller, a personal computer, a solid state electronic control, a field programmable gate array, etc. The third means may also be any now-existing or future-existing equivalent to the above referred-to systems, devices, or apparatuses.

In some embodiments, the system may also include a fourth means for storing a table of targets and their relative positions. In these embodiments, the fourth means may be any system, device or apparatus discussed herein capable of storing a table of targets and their relative positions. Merely by way of example, in some embodiments, the fourth means may be a data store, for instance, a hard drive, a solid state memory device (i.e. flash memory), etc. The fourth means may also be any now-existing or future-existing equivalent to the above referred-to systems, devices, or apparatuses.

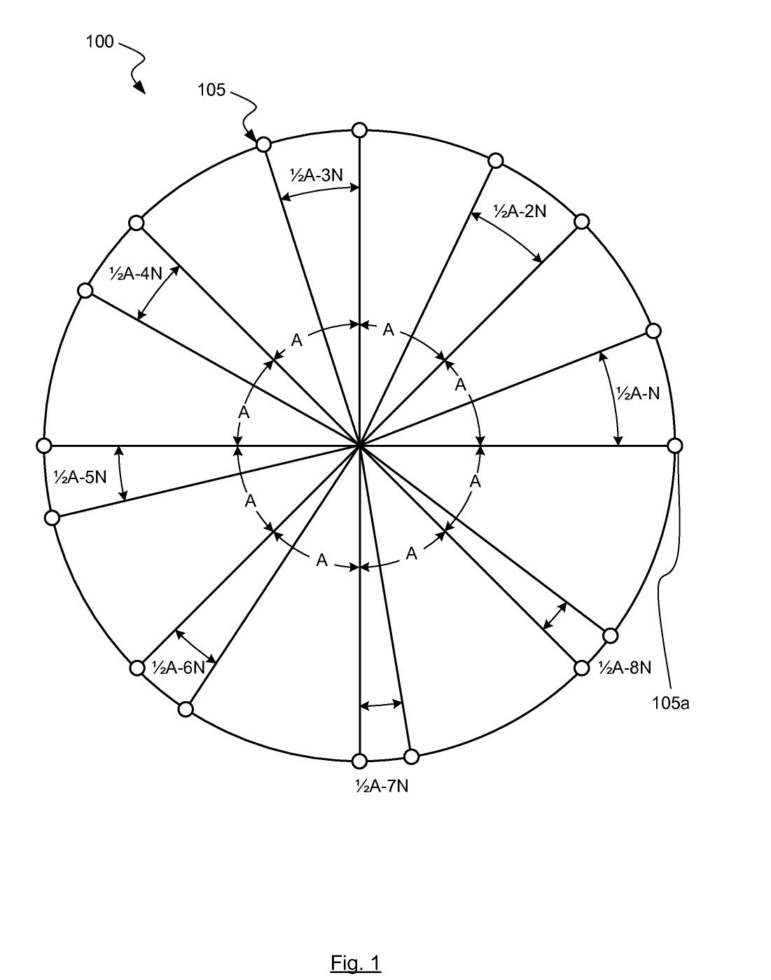

Turning now to FIG. 1, a geometric representation 100 of one possible layout of targets 105 of the invention is shown. Placing target 105 to achieve full coverage of a complete rotation where the radial distance between any two adjacent targets 105 is substantially not equal to the radial distance between any other two adjacent targets 105 may be achieved in any numerous number of ways, one of which is shown here.

First, a base target 105a is provided. Then every other target 105 is placed at a fixed distance (A) from each other. Targets 105 are then placed between those every-other targets 105 at an offset from the midway point between surrounding every-other targets 105. This particular method of placing targets 105 may be appropriate when the rotatable object regularly makes one or more complete rotations during operation.

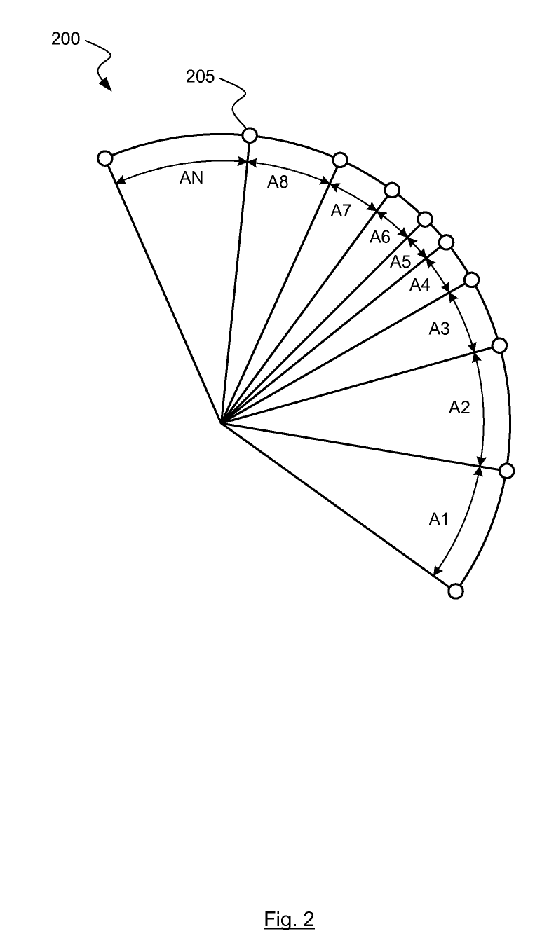

FIG. 2 shows a geometric representation 200 of another possible layout of targets 205 of the invention. This particular method of placing targets 205 may be appropriate when the rotatable object regularly occurs in a limited-arc range. In this embodiment, targets 205 are all place at varying distances from each other, but are placed at smaller distances from each other in the primary range of operation. In ranges where operation is sparse, targets 205 are placed further apart, but remain at varying distances from each other.

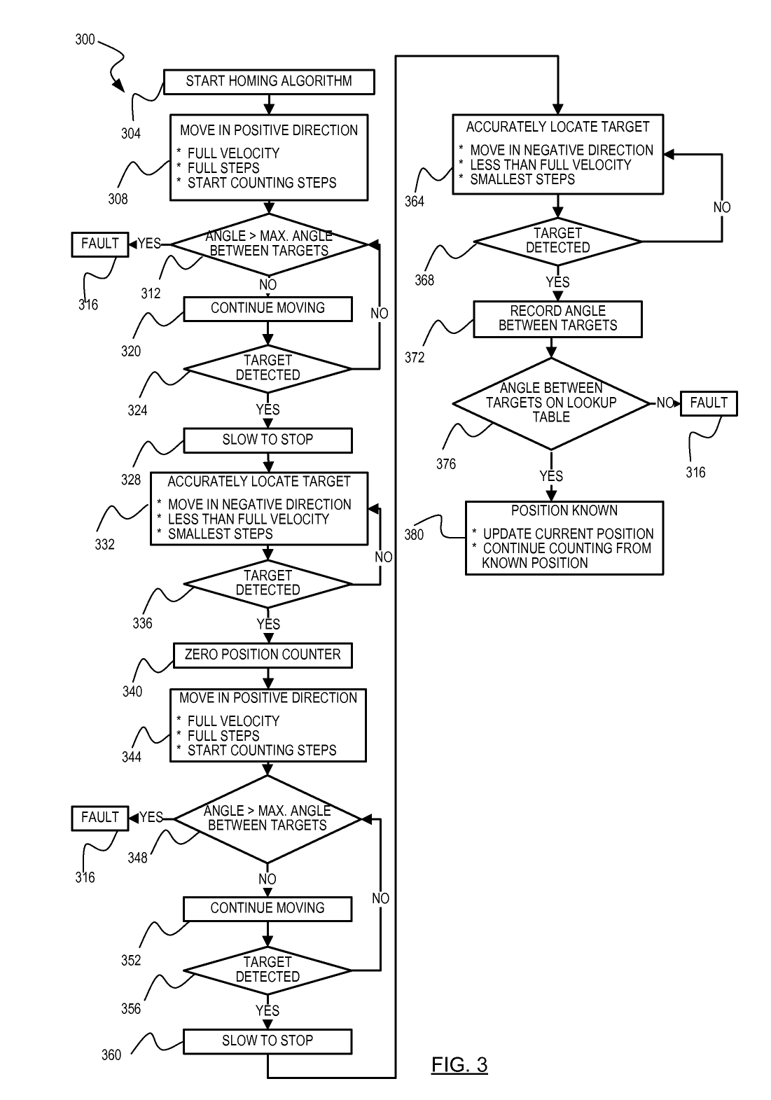

FIG. 3 shows a block diagram of a method 300 of the invention for determining an initial position (homing) of a rotatable object. While many different methods are possible using the above-described targets of the invention, methods of the invention for determining an initial position of a rotatable object may (a) detect if a failure occurs during homing operations, (b) possibly minimize startup time by operating at high velocity, and (c) maximize accuracy and repeatability of target detection by operating at low velocity. The following method 300 may be especially pertinent to continuously rotating embodiments.

In this embodiment, method 300 may include a step 304 of determining to start homing, either by power up or slippage detection. Method 300 may further include a step 308 of rotating/moving in the positive direction by ramping to full velocity and full step size, while counting steps. Method 300 may also include step 312 of determining whether the angle measured, in number of steps taken, is larger than the maximum angle between targets plus, then stop homing algorithm and register a fault at block 316. Otherwise, movement will continue at block 320.

When a target is detected at block 324, then movement may be slowed to a stop at block 328. Then, at block 332, using the smallest step size, movement may occur slowly in the negative direction. At block 336, if the target is detected, the position counter is zeroed at block 340.

At block 344, the object is rotated in the positive direction by ramping to full velocity and full step size, while counting steps from the first target detected. At block 348, the angle is measured, in number of steps taken, if larger than the maximum angle between targets, then the homing algorithm is stopped and a fault is registered at block 316.

At block 352, movement continues until a target is detected at block 356. Movement is slowed to a stop at block 360, and then, using the smallest step size, movement is recommenced slowly in the negative direction at block 364. If a target is detected at block 368, the angle between the targets is recorded at block 372. At block 376, if the angle between targets is not on the look up table, within the tolerance of sensor repeatability, then a fault is registered at block 316. However, if the distance between targets is on the look up table, allowing for tolerances also in the look up table, then update the current position and register that the homing algorithm has been successfully completed at block 380.

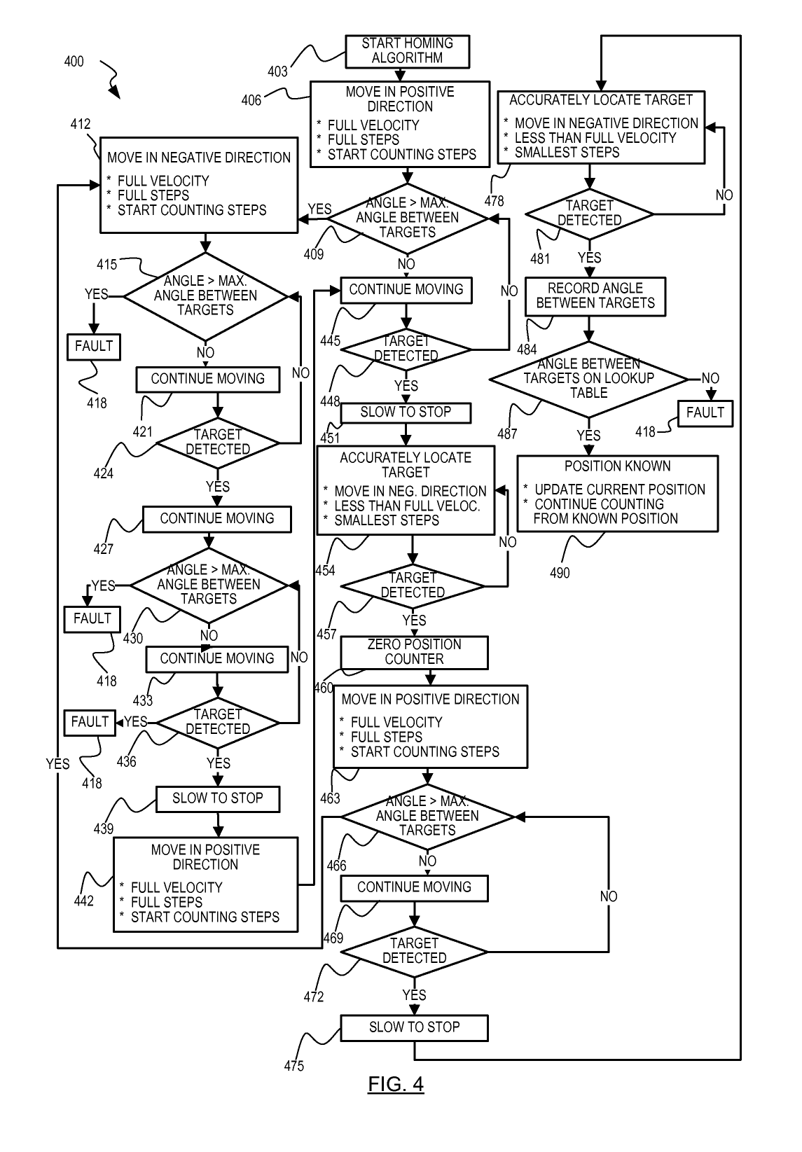

FIG. 4 shows a block diagram of another method 400 of the invention for determining an initial position (homing) of a rotatable object. While many different methods are possible using the above-described targets of the invention, methods of the invention for determining an initial position of a rotatable object may (a) detect if a failure occurs during homing operations, (b) possibly minimize startup time by operating at high velocity, (c) maximize accuracy and repeatability of target detection by operating at low velocity, and (d) detect end of arc-travel conditions. The following method 400 may be especially pertinent to partial-arc rotating embodiments.

Method 400 may include step 403, which may determine to start homing, either by power up or slippage detection. At block 406, movement may be commenced in the positive direction by ramping to full velocity and full step size, while counting steps. At block 409, the angle moved is measured, in number of steps taken, and if larger than the maximum angle between targets, then motion is stopped. If motion is not stopped at block 409, then block 445 is referenced. If motion is stopped in block 409, then movement is commenced in the negative direction by ramping to full velocity and full step size at block 412.

Motion is then stopped after passing two targets in blocks 415-439. If two targets are not detected in blocks 415-439, then the homing algorithm is stopped and a fault is registered in block 418. If two targets are detected in block 415-439, then movement is commenced in the positive direction by ramping to full velocity and full step size while counting steps at block 442.

Movement is then continued in block 445 until a target is detected at block 448. When a target is detected, movement is slowed to a stop at block 451. Using the smallest step size, movement then commences slowly in the negative direction at block 454 until a target is detected at block 457. The position counter is then zeroed at block 460.

At block 463, movement in the positive direction is commenced by ramping to full velocity and full step size, while counting steps from the first target detected. At block 466, if the angle measured, in number of steps taken, is larger than the maximum angle between targets, then motion is stopped and blocks 412-442 are repeated.

Otherwise, at block 469 movement is continued, and at block 479 if a target is not detected, then block 466 is repeated. If a target is detected then movement is slowed to a stop at block 475. Using the smallest step size, movement slowly commences in the negative direction at block 478 until a target is detected at block 481. The angle between the targets is recorded at block 484, and compared to targets on the lookup table at block 487. If the angle between targets is not on the lookup table, within the tolerance of sensor repeatability, then a fault is registered at block 418. However, at block 490, if the distance between targets is on the look up table, allowing for tolerances also in the look up table, then the current position is updated and it is further registered that the homing algorithm has been successfully completed.

Using methods similar to those detailed above in respect to FIG. 3 and FIG. 4, and possibly after such homing operations, it is possible to detect slippage when either: (a) a target is not detected when the target sensor and processor package indicates that a target should be detected; or (b) a target is detected when the target sensor and processor package indicates that a target should not have been detected.

Tolerances on look up tables may have tolerance values which are large enough such that: (a) false faults are not reported during operation or homing before calibration is completed; and (b) slippage detection, discussed below, is still useful for detecting gross failure of calibration methods, discussed above. However, tolerances may also be small enough that operation and error detection is possible without running calibration algorithms. Tolerances should allow for sensor repeatability over time, temperature, and other environmental variables, as well as sensor hysteresis.

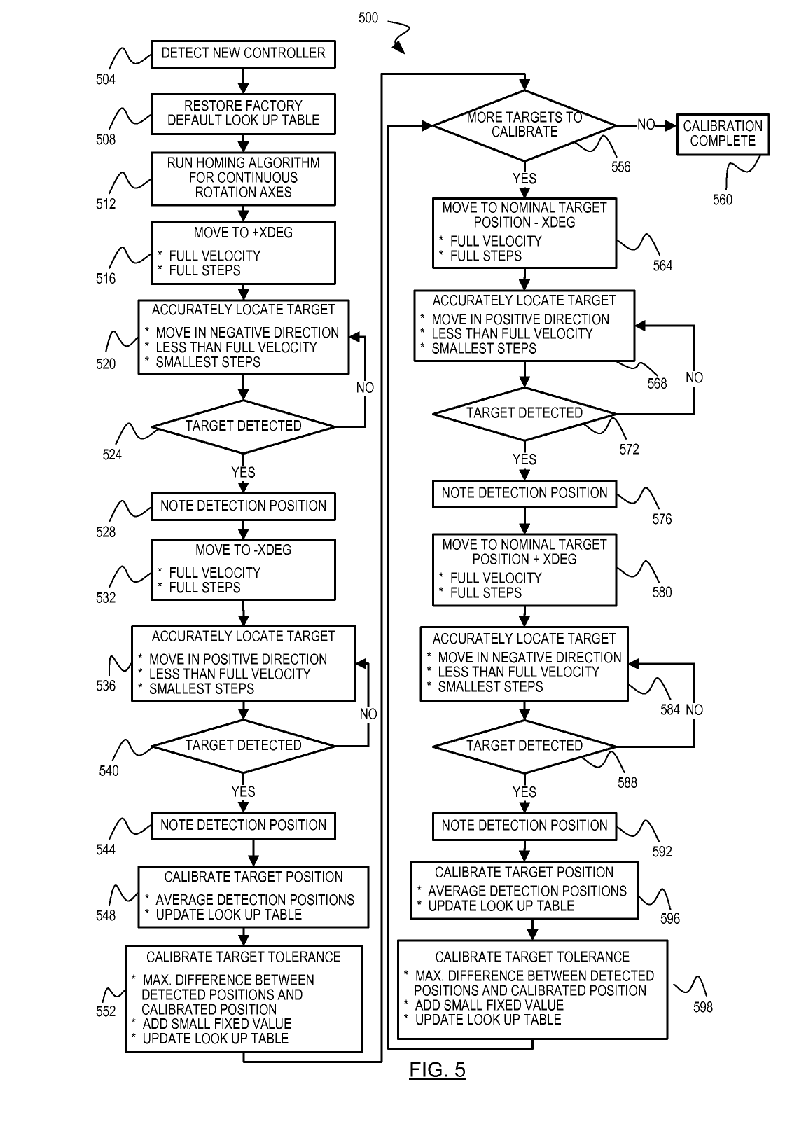

FIG. 5 shows a block diagram of a method 500 for calibrating a system of the invention. While many different methods are possible using the above-described targets of the invention, methods of calibrating the systems of the invention may account for: (a) mechanical tolerance in target placement; (b) mechanical tolerance in sensor placement; (c) direction of travel; (d) sensor repeatability; and (e) sensor hysteresis. Calibration may also need to occur when a new controller or sensor is implemented with a particular system. In some embodiments, coupling of new equipment with a system may be automatically detected. The following method 500 may be especially pertinent to continuously rotating embodiments.

At block 504, a new controller is detected when it is connected to the system. At block 508, any previous look up table is restored to factory defaults containing nominal target positions and tolerances. At block 512, a homing method, possibly one described above such as method 300, is run.

At block 516, at full velocity and full step size, movement to a position just positive of the zero position is commenced. At block 520, at the smallest step size, slow movement is commenced in the negative direction until the target is detected. When the target is detected at block 524, the detection position is noted at block 528.

At block 532, at full velocity and full step size, movement is commenced to a position just negative of the zero position. At block 536, at the smallest step size, slow movement is commenced in the positive direction until the target is detected at block 544. The position of the target is noted at block 544.

At block 548, half the distance between the target detected in block 528 and the target detected in block 544 is set as the calibrated zero position. At block 552, the larger distance from calibrated zero to the targets detection in blocks 528 and 544 is added to a small fixed value and set as the tolerance for the calibrated zero position.

At block 556, it is determined if there are more targets to calibrate. If not, at block 560, calibration is completed. However, for each additional target, blocks 564-598 are completed.

At block 564, movement in the positive direction is commenced at full velocity and full step size. At block 568, movement is slowed to a stop at a position just negative of next target. At block 572, if a target is not detected, block 568 repeats. If a target is detected, at block 576, the new target position is noted.

At block 580, movement is commenced in the smallest step size, slowly in the positive direction until the target is detected. Movement is slowed to a stop at a position just positive of the target being calibrated. At block 584, movement commences at the smallest step size slowly in the negative direction until the target is detected at block 588. The position of the target is noted at block 592.

At block 596, the average position, relative to the zero set in block 548, of the last target detected in is set as the calibrated position for the target. At block 598, the largest distance from the calibrated position and the last target detection is added to a small fixed value and set as the tolerance for the calibrated target position.

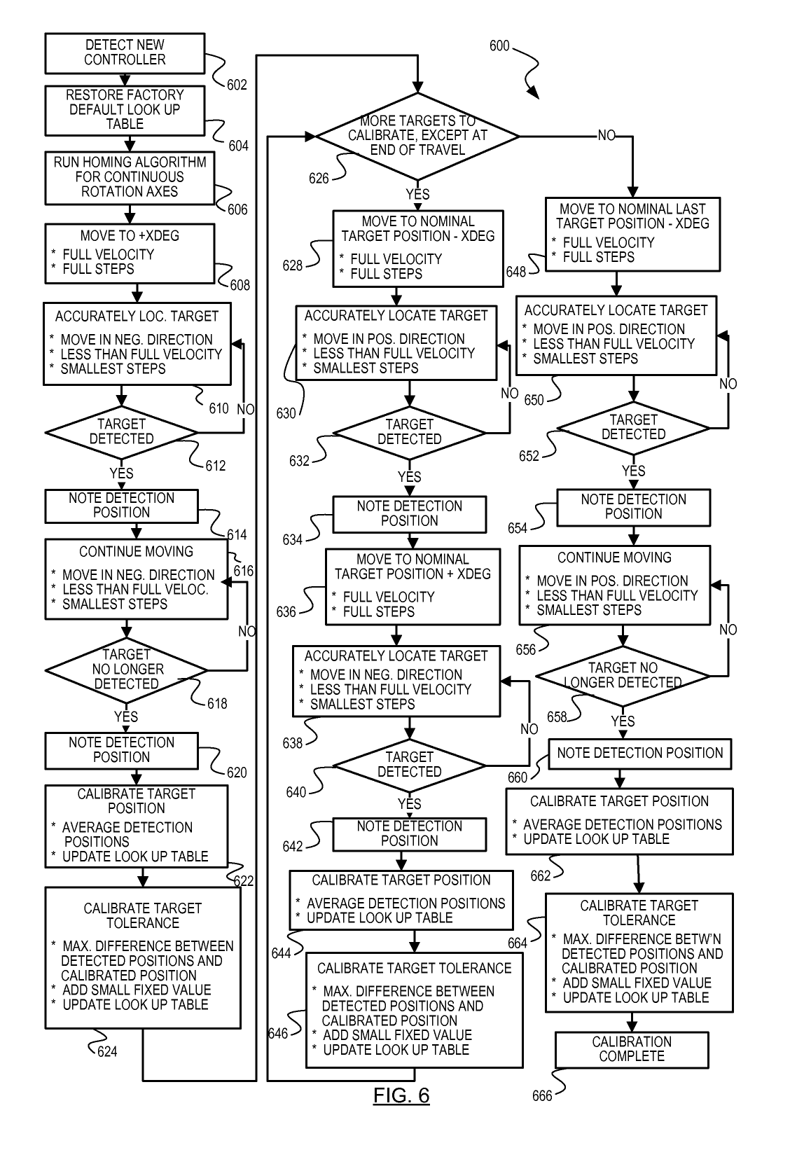

FIG. 6 shows a block diagram of another method 600 for calibrating a system of the invention. While many different methods are possible using the above-described targets of the invention, methods of calibrating the systems of the invention may account for: (a) mechanical tolerance in target placement; (b) mechanical tolerance in sensor placement; (c) direction of travel; (d) sensor repeatability; and (e) sensor hysteresis. Calibration may also need to occur when a new controller or sensor is implemented with a particular system. In some embodiments, coupling of new equipment with a system may be automatically detected. The following method 600 may be especially pertinent to partial-arc rotating embodiments.

At block 602, a new controller is detected when it is connected to the system. At block 604, any previous look up table is restored to factory defaults containing nominal target positions and tolerances. At block 606, a homing method, possibly one described above such as method 400, is run.

At block 608, at full velocity and full step size, movement to a position just positive of the zero position is commenced. At block 610, at the smallest step size, slow movement is commenced in the negative direction until the target is detected. When the target is detected at block 612, the detection position is noted at block 614.

At block 616, movement is continued slowly in the negative direction until the target is no longer detected at block 618. The position of the last target is noted at block 620.

At block 622, half the distance between the target detected in block 614 and the target detected in block 620 is set as the calibrated negative end of travel. At block 624, the larger distance from calibrated zero to the targets detection in blocks 614 and 620 is added to a small fixed value and set as the tolerance for the calibrated target position.

At block 626, it is determined if there are more targets to calibrate and the end of travel has not been reached. If so, at block 628, movement in the positive direction is commenced at full velocity and full step size. At block 630, movement is slowed to a stop at a position just negative of next target. At block 632, if a target is not detected, block 630 repeats. If a target is detected, at block 634, the new target position is noted.

At block 636, movement is commenced in the smallest step size, slowly in the positive direction until the target is detected. Movement is slowed to a stop at a position just positive of the target being calibrated. At block 638, movement commences at the smallest step size slowly in the negative direction until the target is detected at block 640. The position of the target is noted at block 642.

At block 644, half the distance between the target detected in block 634 and the target detected in block 642 is set as the calibrated position for the target. At block 646, the larger distance from calibrated zero to the targets detection in blocks 634 and 642 is added to a small fixed value and set as the tolerance for the calibrated target position.

Once the end of travel has been reached and the final two targets are to be calibrated, at block 648 movement in the positive direction is commenced at full velocity and full step size. At block 650, movement is slowed to a stop at a position just negative of next target. At block 652 if a target is not detected, block 650 repeats. If a target is detected, at block 654, the new target position is noted.

At block 656, movement is continued slowly in the negative direction until the target is no longer detected at block 658. The position of the last target is noted at block 660. At block 662, half the distance between the target detected in block 654 and the target detected in block 660 is set as the calibrated position for the target. At block 664, the larger distance from calibrated zero to the targets detection in blocks 654 and 660 is added to a small fixed value and set as the tolerance for the calibrated target position. At block 666, calibration is complete.

The invention has now been described in detail for the purposes of clarity and understanding. However, it will be appreciated that certain changes and modifications may be practiced within the scope of the appended claims.

What is claimed is:

1. A method for determining the radial position of a rotatable object, wherein the method comprises:
providing a plurality of targets at known relative radial positions coupled with the object, wherein a radial distance between any two adjacent targets is substantially not equal to the radial distance between any other two adjacent targets;
rotating the object about an axis, wherein the distance of the rotation is believed to be known;
determining, during rotation of the object, that a first target is at least in proximity to a point fixed relative to the axis;
determining, during rotation of the object, that a second target is at least in proximity the point fixed relative to the axis; and
comparing of the believed known rotation with the known relative radial positions of the plurality of targets.

2. The method for determining the radial position of a rotatable object of claim 1, wherein the method further comprises:
determining an initial radial position of the object based on a similarity of the believed known rotation and the known relative radial positions of the plurality of targets, as revealed by the comparison of the believed known rotation with the known relative radial positions of the plurality of targets.

3. The method for determining the radial position of a rotatable object of claim 1, wherein the method further comprises:
determining a current radial position of the object based on a similarity of the believed known rotation and the known relative radial positions of the plurality of targets, as revealed by the comparison of the believed known rotation with the known relative radial positions of the plurality of targets.

4. The method for determining the radial position of a rotatable object of claim 1, wherein the method further comprises:
determining that an unintended slippage of the radial position of the object has occurred based on a discrepancy between the believed known rotation and the known relative radial positions of the plurality of targets, as revealed by the comparison of the believed known rotation with the known relative radial positions of the plurality of targets.

5. The method for determining the radial position of a rotatable object of claim 1, wherein providing a plurality of targets at known relative radial positions coupled with the object, wherein a radial distance between any two adjacent targets is substantially not equal to the radial distance between any other two adjacent targets comprises:
providing a first plurality of targets at evenly spaced distances from each other around the entire axis; and
providing a second plurality of targets, wherein:
each of the second plurality of targets is located between two of the first plurality of targets; and
each of the second plurality of targets is located at a different relative position between the closest two targets of the first plurality of targets.

6. The method for determining the radial position of a rotatable object of claim 1, wherein providing a plurality of targets at known relative radial positions coupled with the object, wherein a radial distance between any two adjacent targets is substantially not equal to the radial distance between any other two adjacent targets comprises, in a sub-arc of the entire axis:
providing a first plurality of targets, wherein each of the first plurality of targets is located within a first range of radial distances from adjacent targets in the first plurality of targets;
providing a second plurality of targets, wherein each of the second plurality of targets is located within a second range of radial distances from adjacent targets in the second plurality of targets, and wherein the second range is of larger values than the first range; and
providing a third plurality of targets, wherein each of the third plurality of targets is located within a third range of radial distances from adjacent targets in the third plurality of targets, and wherein:
the third range is of larger values than the first range; and
the third plurality of targets is at an opposite end of the first plurality of targets from the second plurality of targets.

7. The method for determining the radial position of a rotatable object of claim 1, wherein:
the method further comprises storing a table of targets and their relative positions; and
comparing of the believed known rotation with the known relative radial positions of the plurality of targets comprises comparing the believed known rotation with at least a portion of the table.

8. The method for determining the radial position of a rotatable object of claim 1, wherein the rotatable object comprises a motor shaft.

9. The method for determining the radial position of a rotatable object of claim 1, wherein the rotatable object comprises a mechanical transmission element downstream from a motor shaft.

10. A system for determining the radial position of a rotatable object, wherein the system comprises:
a plurality of targets at known relative radial positions coupled with the object, wherein a radial distance between any two adjacent targets is substantially not equal to the radial distance between any other two adjacent targets;
a sensing device, in a position fixed relative to an axis of the rotatable object, configured to determine, during rotation of the object, that any of the plurality of targets is at least in proximity to the sensing device; and
a processor configured to compare a believed known rotation of the rotatable object with the known relative radial positions of the plurality of targets.

11. The system for determining the radial position of a rotatable object of claim 10, wherein:
the system further comprises a data store including a table of targets and their relative positions; and
the processor being configured to compare a believed known rotation of the rotatable object with the known relative radial positions of the plurality of targets comprises the processor comparing the believed known rotation with at least a portion of the table.

12. The system for determining the radial position of a rotatable object of claim 10, wherein the processor is further configured to:
determine an initial radial position of the object based on a similarity of the believed known rotation and the known relative radial positions of the plurality of targets, as revealed by the comparison of the believed known rotation with the known relative radial positions of the plurality of targets.

13. The system for determining the radial position of a rotatable object of claim 10, wherein the processor is further configured to:
determine a current radial position of the object based on a similarity of the believed known rotation and the known relative radial positions of the plurality of targets, as revealed by the comparison of the believed known rotation with the known relative radial positions of the plurality of targets.

14. The system for determining the radial position of a rotatable object of claim 10, wherein processor is further configured to:
determine that an unintended slippage of the radial position of the object has occurred based on a discrepancy between the believed known rotation and the known relative radial positions of the plurality of targets, as revealed by the comparison of the believed known rotation with the known relative radial positions of the plurality of targets.

15. The system for determining the radial position of a rotatable object of claim 10, wherein the system further comprises the rotatable object, and wherein the rotatable object comprises a stepper motor.

16. A system for determining the radial position of a rotatable object, wherein the system comprises:
a first means for rotating the rotatable object a distance, wherein the distance is believed to be known;
a plurality of targets at known relative radial positions coupled with the object, wherein a radial distance between any two adjacent targets is substantially not equal to the radial distance between any other two adjacent targets;
a second means for determining, during rotation of the object, that any of the plurality of targets is at least in proximity to the second means;
a third means for comparing of the believed known rotation with the known relative radial positions of the plurality of targets.

17. The system for determining the radial position of a rotatable object of claim 16, wherein the first means comprises at least a portion of a motor.

18. The system for determining the radial position of a rotatable object of claim 16, wherein the second means comprises at least a portion of a sensing device.

19. The system for determining the radial position of a rotatable object of claim 16, wherein the third means comprises a processor.

20. The system for determining the radial position of a rotatable object of claim 16, wherein the system further comprises:
a fourth means for storing a table of targets and their relative positions.
